(19) United States
(12) Patent Application Publication
(10) Pub. No.: US 2018/0025119 A1
(43) Pub. Date: Jan. 25, 2018

(54) SECURE PRESCRIPTION OF A MEDICAL SOFTWARE DEVICE

(71) Applicant: VOLUNTIS, Paris (FR)

(72) Inventors: Barthelemy SIRE, Courbevoie (FR); Julien CURRO, Lyon (FR); Yannick MOALIC, Paris (FR); Dominique BUREY, Brunoy (FR); Etienne VIAL, Poissy (FR); Romain MARMOT, Belmont, MA (US)

(21) Appl. No.: 15/549,925

(22) PCT Filed: Jan. 25, 2016
(86) PCT No.: PCT/FR2016/050147

§ 371 Date: Aug. 9, 2017

(30) Foreign Application Priority Data
Feb. 12, 2015 (FR) 15 51148

(51) Int. Cl. G06F 19/00

(52) U.S. Cl. CPC G06F 19/3412; G06F 19/3456; G06F 19/3418

(57) ABSTRACT

Disclosed is a computer system for activation of a software application capable of executing software functions on a communication terminal in order to assist a patient in a therapeutic treatment determined according to a computerized medical prescription including personal prescription data containing information associated with the treatment prescribed to the patient, the system including:—a database storing the application and the computerized medical prescription; an authentication unit for authenticating the patient to the system using the communication terminal; an activation unit for remotely activating the application and the prescription data on the communication terminal in order to execute the software functions.

### TECHNICAL FIELD AND PRIOR ART

The object of this invention relates to the field of medical devices, and relates more particularly to medical software devices.

Software can now be considered as a medical device, in so much as it is intended to be used specifically for medical purposes in particular diagnostic and/or therapeutic purposes.

This is referred to as a medical software device.

The software functions executed by a medical software device are often provided in order to assist a patient in a therapeutic treatment; these functions can for example assist the patient in the dosage of a medication.

The software as a medical device can therefore directly influence the health of the patient.

It is as such understood that a medical software device favours the medical care of the patient, the latter with the condition that the software functions executed on the medical software device comply with the medical prescription specifically established by the doctor for his patient.

Inversely, such a medical software device is able to represent a risk for the patient if one of the functions executed by the medical software device is not compliant with the medical prescription, for example if the dosage of the medication is not correct.

Take the concrete example of an asthma patient: using a medical software device intended to assist the patient in the treatment of the asthma can allow for the automatic determining of the dose of a bronchodilator in order to prevent or limit the asthma attack; this can be done according in particular to:
information concerning the Peak Expiratory Flow (PEF) measured using suitable measuring equipment, and
a medical prescription established by a specialist doctor taking into consideration personal medical information concerning the patient (for example: his type of asthma, his age, his weight, his regular activity, his possible medical history, etc.).

The dosage of the bronchodilator by the medical software device must be compliant with the medical prescription established by the doctor and the state of health of the patient taking into consideration the personal medical information hereinabove.

It is understood here that an error in the determination of this dosage can have consequences of the health of the patient, with such a dosage error able in some extreme cases lead to the death of the patient.

Of course this example with asthma is one example among others: it is entirely possible to provide a medical software device to assist the patient in the treatment of other types of pathologies such as for example the treatment of cardiovascular disorders, diabetes, multiple sclerosis (MS), or that of epilepsy.

In order to limit these risks linked to the use of a medical software device, document WO 2014/125235 belonging to the Applicant is already known.

This document as such relates to a “surveillance” computer system that involves monitoring all of the risks linked to the failure or misuse of one of the functions offered by the software.

The system proposed in this document continuously checks that the medical software device is used in the conditions and for the intended purposes by both the manufacturer but also by the doctor.

More particularly, the system proposed in this document is configured to systematically identify all of the software, hardware and/or computer risks linked to the medical software device:
a computer or software incompatibility,
an incorrect update,
an obsolete operating system,
an unsynchronised clock,
an interoperability issue,
an unsupported auxiliary device model,

etc.

The system proposed in this document is furthermore configured to remotely activate or deactivate the medical software device when a risk has been identified.

The system proposed in this document therefore seeks to prevent the software, hardware and/or computer risks that result from a failure or a misuse of the medical software device.

The Applicant however submits that to date there is no system that seeks to verify that the medical software device is operating correctly by complying with the medical recommendations of the doctor.

In other terms, no solution today is proposed to check that the medical software device is complying with the medical prescription.

In a conventional situation, the delivery of a health product such as a medication or a medical device is supervised in order to prevent the risks of accidents linked to this health product.

The doctor, following a consultation, therefore establishes on sheet a medical prescription wherein he indicates the treatment to be followed for the patient with:
the medication or medications and/or,
the medical device or devices associated with this treatment for example a self-tensiometer for the treatment of a disease such as high blood pressure.

This prescription can therefore contain information concerning the posology of the medication, the recommended dose, the period of the treatment, any medical contra-indications due to history or to the taking of other incompatible medications, the instructions for use of the medical device, the normal expected values for a measurement taken with the device, etc.

This prescription also contains the identification number of the doctor, the last name and the first name of the patient.

The patient must then take this prescription and go for example to a pharmacy and retrieve the medication or medications in question as well as the medical device or devices in question.

Once the patient has returned home, he must scrupulously follow the recommendations of the doctor by taking his medications and/or by using the associated medical device according to the recommendations mentioned on the prescription; i.e. by complying in particular with the posology, the dosage and the treatment period or the rhythm and the mode of use of the medical device or devices prescribed.

In the context of medical software devices, the situation is different.

Indeed, with the appearance of medical software devices, certain characteristics of the treatment, such as for example the determining of the dosage of a medication, are carried out automatically by specific software functions configured according to the recommendations of the doctor.

A portion of the treatment is therefore dematerialised and transferred into the software functions of the medical software device.

This new approach for treating the patient gives rise to many problems that have not been solved until now.

One of the technical problems raised with the appearance of such medical software devices is to find a solution pour for prescribing a software application to be installed in the same way as a doctor or a healthcare professional would prescribe a conventional medical device.

A first solution could be to note on a prescription, paper version, the name of the software application to be installed on the communication terminal used as a medical device.

The installation of the software application on the communication terminal of the patient would then be free and would be carried out via a download server of the “store” type such as for example “AppStore®”.

This solution would however have several disadvantages:
the patient can lose the prescription whereon the name of the application to be installed is noted;
the patient can forget to install the application;
the patient may not know how to install such an application.

One of the other technical problems raised with the appearance of medical software devices is to find a solution in order to ensure that the patient has correctly installed the application on his communication terminal.

A first solution could be to ask the patient to confirm for example by email or by SMS to the prescribing doctor that he has indeed installed the application.

This solution would however have many disadvantages:
the patient can forget to confirm the installation of the application. In this case, the doctor does not know if his patient has started the treatment prescribed;
the prescribing doctor must bear the responsibility of following his patient.

Another technical problem raised with the appearance of medical software devices is to find a solution in order to establish the link between the patient and the doctor who prescribed the application.

For this, a solution must first be provided to check that the prescription was indeed issued by a doctor.

Then, for example the doctor could be asked, after having prescribed the application to his patient, to record it on the server that is hosting the application. Once the application is installed, the patient would then enter his last name, his first name, and his date of birth in order to connect to the application, the first time the patient connects to the server.

During his next synchronisation, the patient would then be identified on the Web server thanks to the information that he entered during his first connection.

This solution would have many disadvantages: if for example the doctor makes an error in the spelling of the last name and/or first name, or in the date of birth of the patient, the link can never be established.

An alternative solution would be to use unique identification information in order to identify the patient. However, in many contexts, this information does not exist or is not available: it is known for example that the Social Security number exists in France but its use is very regulated and does not guarantee the uniqueness of the individual.

One of the other technical problems raised with the appearance of medical software devices is to find a solution that prevents the patient from using his application without validation from the doctor.

This question is very important from a medical standpoint in particular to ensure the safety of the patient.

This is the case for example of a software application that requires a configuration and specific settings adapted to the patient.

Such configuring is required for example for the specific dosage of a medication, or for the self-dosage rules for the medication by the patient.

Generally, it must be ensured that the settings of the medical software device are compliant with the recommendations of the doctor.

A solution in order to remedy this other problem would be for example that the doctor ask (via an electronic message of the email or SMS type, or by telephone) the patient to wait for his confirmation before using the mobile application, and that the doctor himself configures the application once the latter is installed.

This solution however would have several disadvantages:
the patient may not be able to read his electronic messages or may not have given the correct telephone number to the doctor. In this case, he cannot receive the information asking him to wait to use the application; he can then incorrectly use the application and for example obtain an incorrect dosage of medication given by default by the application;
the patient can also be tempted to use the application (by curiosity) without waiting for confirmation from the doctor and make incorrect us of it in this case.

Such a solution is moreover constraining for the doctor.

In any case, none of the solutions considered until today in prior art propose a computer system that is easy to deploy, that limits the interactions between the doctor and the patient, and that makes it possible to limit the risks of incorrect use of one or several software functions executed by a medical software device.

### OBJECT AND SUMMARY OF THIS INVENTION

This invention aims to improve the situation described hereinabove.

This invention is in line with the same safety approach as that of document WO 2014/125235 and aims to overcome the various disadvantages mentioned hereinabove by ensuring that the configuration of the software functions in order to assist the patient in their treatment is rigorously compliant with the medical prescription established by the doctor specifically for his patient.

To this effect, the object of this invention relates according to a first aspect to a method for activating a software application capable of executing on a software functions on a communication terminal in order to assist a patient in a determined therapeutic treatment.

According to the invention, the communication terminal is used here as a medical software device.

In the framework of this invention, the therapeutic treatment that the patient must follow is determined according to a computerised medical prescription.

This computerised medical prescription is stored in a database connected to a remote central server.

The software functions executed by the software application on the communication terminal must therefore follow this prescription.

These are software functions that make possible for example:
the dosage of a bronchodilator for the treatment of asthma,
the following of the observance of the treatment for certain autoimmune diseases,
the dosage of an anticoagulant for the treatment of certain cardiac disorders,
the dosage in carbamazepine for the treatment of epilepsy,
etc.

Of course, these examples of functions do not have a limiting nature in any way and are purely for the purposes of illustration; those skilled in the art understand here that other functions concerning the field of the medical device can be considered in the framework of this invention in order to assist a patient in the treatment of other pathologies.

This computerised medical prescription comprises in a characteristic manner personal prescription data containing information associated with the treatment prescribed to the patient.

Preferably, the personal prescription data include in particular information concerning:
the patient,
the practitioner, and/or
the medication prescribed by the practitioner for the treatment of the patient.

These prescription data can also contain information concerning the medical device; this can be for example information concerning in particular:
the dosage of said prescribed medication, and/or
the self-dosage rules for this medication by the patient himself, and/or
the associated posology, and/or
the normal measurement values by an associated medical device.

These prescription data are intended to be executed and/or used for the execution of at least one of the software functions of the software application installed on the communication terminal.

These prescription data can also include technical characteristics of the medical software device and/or configuration parameters of the software functions.

These prescription data are characteristic of this invention.

The method is advantageously implemented by computer means and comprises the following steps:
following an installation of the application on the communication terminal, a step of authenticating the patient with the central server via the communication terminal;
when the patient is authenticated with the central server, a step of remotely activating the application and prescription data on the communication terminal in order to authorise the execution of at least one of the software functions on the terminal.

This invention therefore consists in:
authenticating the patient using the communication terminal whereon the application is installed with a central server storing the computerised medical prescription, then
activating the application and prescription data in order to allow for the execution and the implementation of at least one of the software functions of the application on the communication terminal.

This succession of technical steps, characteristic of this invention, makes it possible to guarantee that the functions executed on the communication terminal comply with the medical recommendations defined by the doctor for his patient in the prescription.

As such, thanks to this authentication and this activation managed by a remote central server, the function used for example to calculate the dosage of a medication performs this calculation according to the prescription data.

As these prescription data are personal and are adapted to the treatment of the patient, the dosage is calculated specifically for the patient according to the recommendations defined by the doctor, not according to a dosage calculation taken by default by the application in its downloadable (not personalised) version.

It can be provided that the step of authenticating also comprises the authentication of the terminal as such. In this case, this authentication of the terminal is done by checking an identifier that is proper to the terminal. This additional authentication makes it possible to verify that the patient is indeed using the authorised terminal (for example the one recommended by the doctor or the one lent by the doctor).

Advantageously, the step of activating comprises a transmission of an activation message intended for the communication terminal.

Preferably, this activation message comprises prescription data and an activation order.

In this mode, the terminal comprises computer means configured to process this message and authorise the activation upon reception of this message.

In an advantageous embodiment, the step of authenticating comprises the comparing by the central server of a code received from the communication terminal with a unique prescription code recorded in the database.

In this mode, it can be provided for example that the patient has been authenticated with the central server if the two compared codes are similar; i.e. here if the code coming from the terminal and received by the server effectively contains the identification information contained in the unique prescription code.

Such a unique prescription code is optional.

Preferably, the method according to this invention comprises a step of generating the unique prescription code according to the prescription data.

This code can also be generated according to the prescription data and a unique identification number.

This unique identification number is generated by the doctor using the personal information concerning the patient and identification information that makes it possible to communicate with the communication terminal: for example a telephone number or an electronic address.

This unique identification number therefore makes it possible to identify the patient and to communicate with him through the intermediary of his terminal.

The prescription of the patient is therefore validated and activated by using this unique prescription code. This unique prescription code therefore makes it possible to authenticate the prescription before activation.

The Applicant submits that an operating mode could also be provided, where the doctor will also authenticate the terminal itself. Typically, this is the case in the context of a clinical study where a terminal is lent to the patient. In this case, there will be a step of authentication of the terminal in order to ensure that the patient can use the application only on the terminal that was supplied to the patient.

Advantageously, the unique prescription code is present in the form of a two-dimensional matrix code.

Preferably, this code is a code of the “Flash Code®” or “QR Code®” type.

This code can be displayed for example on the screen of the computer of the doctor or can be affixed on predefined coupons used as a prescription.

Preferably, this two-dimensional matrix code contains information relative to the configuration parameters of the software functions executed on said medical device.

Advantageously, the method according to this invention comprises a step of optical reading of the unique prescription code, for example by means of optical reading of the communication terminal.

It is therefore understood here that the patient can read the matrix code with his communication terminal directly from the screen of the computer of the doctor or using the coupon given to the patient by the doctor and used as a prescription.

In an advantageous embodiment, the method according to this invention comprises, following authentication, a step of emitting during which the central server emits an access code with a limited duration.

This access code is emitted intended for the communication terminal.

Alternatively, the latter can be emitted to another terminal that belongs to the patient.

This code advantageously makes it possible to authorise the activation of the application and the prescription data.

This is advantageous for example:
when the patient does not want to immediately install the application, and that he prefers to install it once he has returned home, or
when the patient does not have his communication terminal during the consultation or when he does not have access to the data network to connect to the server.

In this mode, it can be provided for example that the access code with a limited duration be sent in a message of the SMS or email type.

The Applicant submits that it is possible to consider the sending alone of the access code with a limited duration; this unique code then makes it possible to authenticate the doctor.

This can correspond to the case wherein the doctor does not need to materialise his prescription for the patient via a specific document.

In this case, the doctor then programs the information concerning the patient; the patient then receives a message that contains only a single code (the single-use access code) which will make it possible to guarantee the origin of the prescription and its recipient.

The verification of the unique prescription code optionally combined with the validation of the access code with a limited duration makes it possible to associate the account of the patient with the doctor who is following him; more particularly, the verification of the unique prescription code allows for a guarantee of the origin (i.e. the prescribing doctor), and the validation of the access code with a limited duration makes it possible to guarantee the recipient (the patient to whom the application was prescribed).

The Applicant submits that the advantage of these two codes makes it possible for the patient to have, when leaving the doctor's office, a physical trace of the prescription that was prescribed to him.

Correlatively, the object of this invention relates according to a second aspect to a computer program.

According to the invention, this program comprises instructions suited for the execution of the steps of the method such as described hereinabove, this in particular when said computer program is executed by at least one processor or a computer.

Such a computer program can use any programming language, and be in the form of a source code, an object code, or an intermediate code between a source code and an object code, such as in a partially compiled form, or in any other desirable form.

Likewise, the object of this invention relates according to a third aspect to a recording support.

Preferably, this support can be read by a processor or computer whereon is recorded a computer program comprising instructions for the execution of the steps of the method such as described hereinabove.

On the one hand, the recording support can be any entity or device that is able to store the program. For example, the support can include a means of storage, such as a USB key or such as a ROM memory, for example a CD-ROM or a ROM memory of the microelectronic circuit type, or a means of magnetic recording such as for example a hard drive.

On the other hand, this recording support can be a support that can be transmitted such as an electrical or optical signal, such a signal able to be conveyed via an electrical or optical cable, by conventional radio by self-directed laser beam or by other means. The computer program according to the invention can be in particular downloaded on a network of the Internet type.

Alternatively, the recording support can be an integrated circuit wherein the computer program is incorporated, with the integrated circuit being adapted to execute or to be used in the execution of the method in question.

The object of this invention relates according to a fourth aspect to a computer system for activating a software application capable of executing software functions on a communication terminal.

According to the invention, the software functions are here provided in order to assist a patient in a therapeutic treatment determined according to a computerised medical prescription; this prescription comprises personal prescription data containing information associated with the treatment prescribed to the patient.

Advantageously, the system for activating according to the invention comprises computer means configured for the implementation of the steps of the method such described hereinabove.

More particularly, the system for activating comprises in particular:
a database that stores the computerised medical prescription;
means of authentication able to cooperate with the first means of communication in order to authenticate the patient via the communication terminal whereon the application is installed;
activation means able to cooperate with first means of communication in order to remotely activate the application and the prescription data on the communication terminal in order to authorise the execution of at least one of said software functions on the terminal.

The object of this invention also relates according to a fifth aspect to a computer server comprising a system for activating such as described hereinabove.

The object of this invention finally relates according to a sixth aspect on a medical software device, comprising a communication terminal whereon a software application is installed and is capable of executing software functions in order to assist a patient in a therapeutic treatment determined according to a computerised medical prescription.

This prescription, stored in a database connected to a remote central server, comprises personal prescription data containing information associated with the treatment prescribed to the patient.

Advantageously, the medical device according to the invention comprises:
an electronic authentication circuit configured for an authentication of the patient with the central server via the terminal; and
an electronic activation circuit configured to activate the application and the prescription data on the communication terminal in order to authorise the execution of at least one of said software functions on the terminal.

In an advantageous embodiment, the authentication circuit is able to cooperate with second means of communication in order to emit to the central server a request comprising a code to be compared with a unique prescription code recorded in the database.

In this mode, the electronic activation circuit is able to cooperate with the second means of communication in order to receive from the server an activation message that comprises prescription data and an activation order.

As such, the object of this invention, through its various functional and structural aspects and described hereinabove, allows for the remote activation of a medical software device in order to guarantee that the execution of the software functions is compliant with a computerised medical prescription established by the doctor specifically for the treatment of the patient.

### BRIEF DESCRIPTION OF THE ANNEXED FIGURES

Other characteristics and advantages of this invention shall appear in description hereinbelow, in reference to the annexed FIGS. 1 and 2 which show an embodiment of it devoid of any limiting nature and wherein:

FIG. 1 diagrammatically shows an embodiment according to this invention with a server comprising a computer system for the remote activation of a software application that can execute software functions on a communication terminal in order to assist a patient in a determined therapeutic treatment; and

FIG. 2 shows a flow chart illustrating the method of activation in accordance with an embodiment of this invention (first scenario—case 1).

### DETAILED DESCRIPTION OF THE VARIOUS EXAMPLE IMPLEMENTED

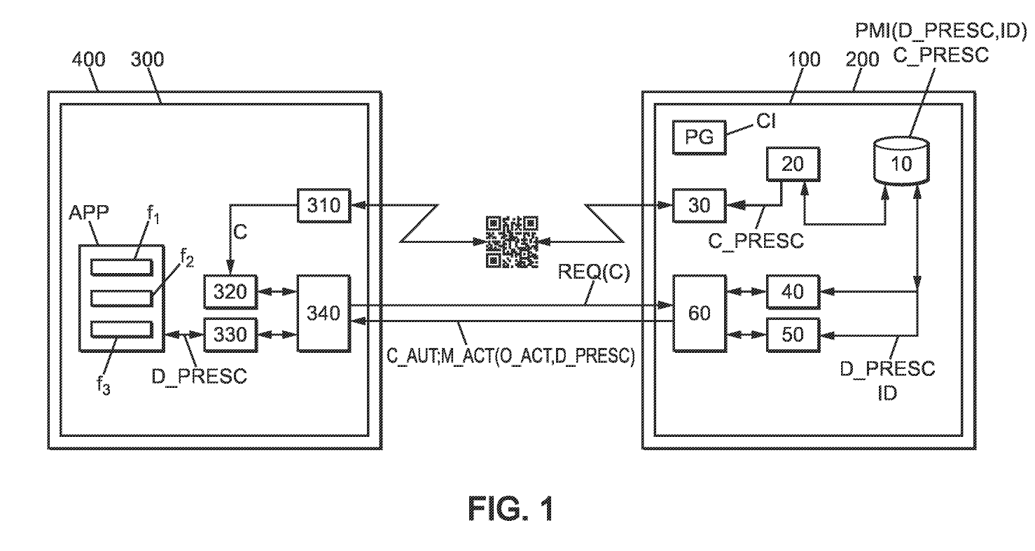

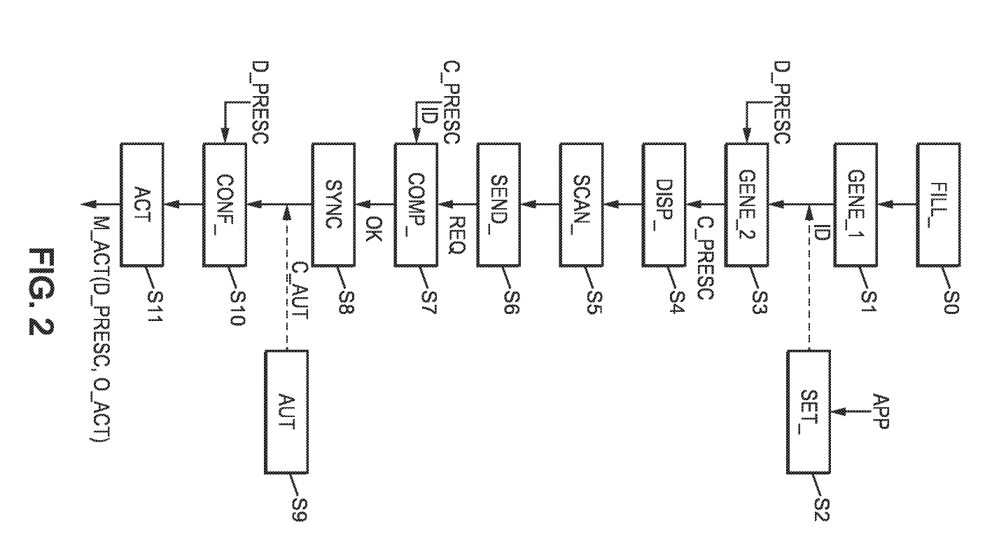

A remote activating of a software application APP that executes at least one of the software functions f1, f2, and f3 on a communication terminal 300 in order to assist a patient in a therapeutic treatment shall now be described in what follows in reference jointly to FIGS. 1 and 2.

In order to treat high blood pressure, the patient must take a medication of the Angiotensin-Converting Enzyme Inhibitor type, noted hereinafter as ACE Inhibitor.

This medication requires a regular adaptation of the posology and of the dosage, according in particular to the systolic blood pressure of the patient and personal data concerning the patient.

The adaptation of this posology and of the dosage of the ACE Inhibitor must therefore be determined by a doctor during a consultation according to the physiological and personal information of the patient collected by the doctor during a consultation:
the age of the patient,
his weight,
his medical history,
his reference systolic blood pressure,
his variations in pressure,
etc.

This posology and this dosage are specific to the patient.

It is understood here that it is not possible to consider the taking of a medication of the ACE Inhibitor type without medical advice, and this for obvious reasons linked to the health of the patient.

Of course, as explained hereinabove, the example of the treatment for hypertension is purely for the purposes of illustration and in no way is of a limiting nature: those skilled in the art understand here that the patient can be assisted in the treatment of any other type of pathology with a medical device according to this invention.

Indeed, the example described here can be transposed without any difficulty to the treatment of another pathology such as for example asthma, MS, diabetes, etc.

Like any medication, a medication of the ACE Inhibitor type must be taken according to the recommendations of a doctor (i.e. according to a medical prescription): the taking of such a medication following a default dosage can be dangerous.

In the example described here, there is a communication terminal 300; this terminal is used as a support for the medical software device 400.

In this example, the medical software device 400 in question must allow for therapeutic assistance of a patient suffering from high blood pressure.

Such a medical device 400 is therefore provided to execute one or several of the software functions f1, f2, and f3 aiming to determine the dosage of the ACE Inhibitor in a dynamic and personalised manner.

It is important for the health of the patient that these software functions f1, f2 and f3 executed on the communication terminal 300 comply with the prescription established by the doctor in order to correctly assist the patient in his therapeutic treatment.

Allowing for the remote activation of a software application APP and of a computerised medical prescription PMI on a communication terminal 300 in order to comply with the recommendations of the doctor is one of the objectives of this invention.

This invention shall be described in more detail according to two scenarios.

### First Scenario:

In this first scenario, it is considered beforehand that the doctor who follows the patient have available during the consultation a connection to the 3G network and access to a central server 200 that can be accessed via a dedicated Web portal.

Likewise, it is considered in this first scenario that the patient has available during this consultation a communication terminal 300 such as a “Smartphone” or a digital tablet, with access to a communication network for example access to the 3G network.

In this example, the patient suffering from high blood pressure therefore comes to see the doctor for a consultation in order to obtain a prescription for a software application APP.

This application APP is dedicated to assisting the patient in the treatment of high blood pressure.

More particularly, in this example, the software application APP under consideration is able to execute software functions f1, f2, and f3 that allow in particular for the automatic calculation of a medication of the ACE Inhibitor type to prevent, delay or limit, and even suppress the risks linked to hypertension.

This application APP is therefore intended to be installed on the communication terminal 300 of the patient.

Ensuring that the calculation of the dosage of medication of the ACE Inhibitor type by the terminal 300 is correctly determined according to the medical prescription established by the doctor for the patient is one of the objectives of this invention.

This is made possible in the framework of this invention by a computer system for activation 100.

This system 100 can be accessed via the computer server 200.

In other terms, the server 200 hosts such a system 100.

According to this first scenario, the doctor connects at the beginning of the consultation to this server 200 via the dedicated Web portal; he keys into during a first step S0 a database 10 of the system 100 personal information concerning the patient, for example:
his last name,
his first name,
his date of birth, and
his telephone number and/or his email address.

Any other combination of information that makes it possible to identify the patient in a reliable manner can also be recorded in this database 10 (for example the Social Security number).

During a step S1, the computer means for generating 20 of the system 100 use this information to generate a unique identification number ID.

This ID number is personal; it is associated with the patient.

Once this ID number is generated, the doctor asks the patient if he wishes to install the prescribed application APP; he has the choice between performing this installation immediately (case 1) or installing it later (case 2), for example when he returns home.

If the patient wishes to install the application APP immediately on his terminal 300, he has a limited period of time to do so (for example 15 minutes); this period of time allows the doctor to certify the identity of the patient and optionally configure the prescription model if necessary.

After this period of time (once back at home for example), the patient can install his application APP only with an access code that will be sent to him either via SMS, or by email.

### Case 1:

In this first case, the patient decides to install the software application APP on his communication terminal 300 within the allotted timeframe.

During a step S2, the patient therefore installs this software application APP on his terminal 300 using a dedicated “Store”, or a “Store” that can be accessed by the public.

It is understood here that this “Store” can be directly associated with the server 200.

Alternatively, it can be a remote server, specially dedicated for downloads. In this example, the doctor then generates a unique prescription code C_PRESC.

This generation is carried out during a step S3 by the means for generating 20 of the system 10.

In the example described here, this code C_PRESC can be the result of an aggregation of personal data concerning the patient, for example the unique identification number ID, and the prescription data D_PRESC which concern the prescription as such.

More particularly, this unique prescription code C_PRESC contains in the example described here the following information:
the date of the prescription,
the unique identification number ID,
the prescription model containing the medications prescribed, their dosage (optionally configurable), and their posology (optionally configurable),
the unique identifier of the doctor, and
the last name and the first name of the doctor.

The prescription model is associated with the pathology and with the medication prescribed.

It therefore comprises pre-populated fields that correspond to the medication, its dosage, its posology, etc.

The values associated with these fields may be able to be configured, for example if the default values are not suited to the patient or if they require specific settings for the patient.

All of this information forms the computerised medical prescription PMI.

This prescription PMI associated with this code C_PRESC is stored in the database 10 of the system 100.

This prescription PMI and this code C_PRESC can also be encrypted. Preferably, the encryption mechanism used is a private key/public key mechanism in order to improve the security of the information that they contain.

The database 10 can also be integrated into a secure module.

The unique prescription code C_PRESC is characteristic of this invention.

Executing the information contain in this code C_PRESC, and more particularly executing prescription data D_PRESC, will make it possible to implement at least one of the software functions f1, f2, and f3 of the application APP in accordance with the medical prescription PMI of the doctor.

Preferably, this code C_PRESC can have the form of a two-dimensional matrix code such as for example a “QR Code” or a “Flash Code”.

In the example described here, this matrix code is displayed on the computer of the doctor during a step S4.

During a step S5, the patient then scans (optical reading) this code using means of optical reading 310 of his communication terminal 310.

Alternatively, the patient can manually enter this code C_PRESC into the application APP that he has just installed.

In one case as in the other, a message is then displayed on the terminal 300 of the patient that indicated to him that the doctor has prescribed this application APP for him.

In order to be able to use the application APP, it must be assured that the latter is correctly configured according to the recommendations of the doctor; i.e. according to the computerised medical prescription PMI.

The patient therefore authenticates the communication terminal 300 whereon the application is installed APP with the system for activation 100 in order to check that the code C scanned or entered by the patient is correct.

This step of authentication therefore comprises a comparison S7 of the code C scanned or entered by the patient on his terminal 300 with the prescription code C_PRESC generated on the system 100.

In order to carry out this comparison S7, the communication terminal 300 comprises an electronic authentication circuit 320 that cooperates during a step S6 with second means of communication 340 in order to emit to the central server 200 a request REQ comprising the code C.

The system 100 receives this request REQ via the means of communication 60; the means of authentication 40 then polls the database 10 in order to compare during this step S7 the code C received with the unique prescription code C_PRESC.

More particularly, in the example described here, this code C is compared with the unique identification number ID contained in the code C_PRESC.

If the two codes are identical, the terminal 300 and the system for activating 100 are synchronised during a step S8.

The system for activation 100 then returns to the terminal 300 the last name and the first name of the patient associated with this unique prescription code C_PRESC.

Optionally, the patient can check the spelling, and correct it if necessary.

If the prescription model contained in the prescription data D PRESC can be configured, the doctor can also configure this model with if necessary parameters that are proper to the patient. This is carried out in a step S10.

During this step, the doctor modifies and/or adds to the prescription data D_PRESC contained in the database 10.

Once configured, it is provided in the example described here a step of activation S11 during which the means of activation 50 emit via the first means of communication 60 an activation message M_ACT intended for the terminal 300.

This message M_ACT comprises an activation order O_ACT and the prescription data D_PRESC.

Upon reception of this message M_ACT, the electronic activation circuit 330 triggers the activation on the communication terminal 300 of the application APP and the prescription data D_PRESC.

The patient can then use the application APP without risk for his health; the software functions f1, f2 and f3 executed are compliant with the medical prescription PMI established by the doctor specifically pour the patient.

### Case 2:

In this second case, the patient decides to install the application later (or the allotted timeframe for the installation has elapsed).

During the consultation, the doctor supplies the database 10 as in the first case.

He generates a prescription code C_PRESC.

The patient returns home and installs the application APP on his terminal 300. He then launches the application APP that he has just installed.

In this example, an authentication of the patient is optionally provided. As such, optionally, after having verified during the authentication that the unique prescription code C_PRESC is valid, the server 200 sends an access code C_AUT with a limited lifespan (for example 48 hours) to the patient either by SMS, or by email.

The patient provided with his terminal enters the access code C_AUT received in the area provided for this purpose.

Then, the patient authenticates himself using the terminal 300 with the server 200 in order to verify that the access code is valid.

Once validated, there are the same steps as in the first case described hereinabove.

The Applicant submits that it is possible that the access code C_AUT unlocks only a portion of the functions of the application.

For example, it can be considered that, based on the unique prescription code C_PRESC, the patient can have access only to functions f1 and f3 and, only after verification of the access code C_AUT, the patient has access to f2.

As such, in a particular example, it can be provided that the patient himself enter his pressure, his pulse or any other medical parameter, and that the function of adapting his dosage of medication would become available only after “final activation” by using the access code C_AUT.

In this example, the mechanism using this code C_AUT has for objective to avoid giving inappropriate medical recommendations (of which some could be fatal) to a bad patient.

The Applicant submits that it is possible to consider an embodiment wherein the doctor supplies the database 10 with the required information and the access code C_AUT with a limited lifespan is sent directly without the unique prescription code C_PRESC being generated.

It is therefore understood that in this case the generating of the code C_PRESC is optional.

### Second Scenario:

In this second scenario, it is considered beforehand that the doctor does not have access to the Web server, and that the patient comes to the consultation without his communication terminal 300 or he does not have access to a communication network.

As in the first scenario, the patient comes here for a consultation in the doctor's office in order to obtain a prescription for an application APP.

In this embodiment, the doctor has a mobile application prescription pad (with carbon copies) for each prescription model.

Each prescription has a unique prescription code C_PRESC stored in the database 10 of the Web server 200 and associated with a health professional.

Each prescription therefore contains:
the unique prescription code C_PRESC (only for the carbon copy);
a prescription model containing the medication or medications prescribed, their dosage (optionally configurable), their posology (optionally configurable) and/or the medical device or devices prescribed as well as the associated characteristics;
the unique identifier of the doctor;
the last name and first name of the doctor.

Any other combination of information that makes it possible to identify the prescription in a unique manner can also be suitable here.

On this prescription, several fields also make it possible to write:
the last name and the first name of the patient,
the date of birth of the patient,
the telephone number or numbers of the patient,
the electronic address of the patient,
the postal address of the patient.

Note here that a prescription may not comprise medication, but solely one or even several medical devices and its characteristics.

Take for example an ophthalmologist that prescribes a pair of glasses: he writes on the prescription the corrective factors for the lenses to be given to the patient, this information here corresponds to the characteristics of the medical device.

In the same way, in the framework of diabetes, a prescription can for example comprise a glucometer configured to operate within a certain unit, an insulin pump with characteristics concerning the insulin flow rates, etc.

During the consultation, the doctor chooses in his prescription pad the model that corresponds to the mobile application to be prescribed to the patient.

He then fills the fields of the prescription with the information supplied by the patient.

The doctor then gives the patient the prescription.

The patient returns home.

### Case 1:

The doctor registers the patient on the Web server 200; he associates to him the unique prescription code C_PRESC (thanks to the carbon copy of the prescription) before the patient has installed the application APP on his terminal 300.

The Web server 200 sends a message to the patient via one of the available channels on the server 200 and according to the known information of the patient:
by SMS if the mobile telephone number is known,
by voice server if only the fixed telephone number is known, or
by email if the electronic address of the patient is known, etc.),

in order to inform him that he can now install the application APP on his terminal 300.

The patient therefore installs the application on his terminal 300 using the dedicated “Store”.

The patient then scans the code mentioned on the prescription or enters it manually into the application APP.

A message is displayed on the terminal 300 informing the patient that the doctor has prescribed this application APP for him.

Then follow the steps as hereinabove.

The patient authenticates his terminal 300 with the server 200 in order to verify that the unique prescription code C_PRESC exists and is known in the database 10.

After having verified that this code is valid, an access code C_AUT (that makes it possible to activate the application) with a limited lifespan (48 h) is sent to the patient either by SMS, or by email.

The patient then launches the application APP that he has installed on his terminal and enters the access code C_AUT received in the area provided for this purpose.

If the patient has not activated the application APP within 48 h, he can ask the doctor to generate a new access code for him and to send it to him.

It is then checked that the access code is valid.

If such is the case, the server then returns the last name and the first name of the patient associated with this unique prescription number.

The patient can verify them and correct them if necessary.

As in the other situations described hereinabove, if the prescription model can be configured, the healthcare professional can configure it on the web server with the parameters that are proper to the patient.

Following these various steps, the patient can use the APP application without risk.

### Case 2:

It is entirely possible to consider another case wherein the patient installs the application APP on his terminal 300 although the doctor has not yet registered him on the Web server.

In this case, the patient therefore installs the application APP using its “Store”.

The patient scans the code C_PRESC mentioned on his prescription or enters it manually into the application.

A message is then displayed on the terminal 300 of the patient that indicated to him that the doctor has prescribed this application APP for him.

The patient authenticates himself with the server 200 in order to check that the unique prescription code C_PRESC exists.

In this case, the server 200 does not find any patient associated with the unique prescription code.

The doctor associated with the unique prescription code is then informed that the patient to whom he has prescribed the application APP, has just installed it on his terminal 200, but he cannot use it as it is not known in the Web server 200.

The doctor in this case registers the patient on the server 200 and associates with him the unique prescription code (thanks to the carbon copy of the prescription).

If the prescription model can be configured, the doctor can configure it on the server 200 with parameters that are proper to the patient.

The Web server 200 then sends a message to the patient to indicate that he can now synchronise the application.

The patient synchronises the application with the web server in order to check that the unique prescription number exists.

Then follow the steps that were described hereinabove.

It is understood here that, regardless of the embodiment chosen, remotely activating the computerised medical prescription, proposed in the framework of this invention, makes it possible to guarantee that the application installed on the terminal executes the software functions by taking into consideration the prescription data that are established by the doctor.

The different approaches described hereinabove and considered in the framework of this invention are reliable and secure solutions that provide healthcare professionals with the assurance that the medical software device 400 operates correctly in accordance with the medical recommendations of the doctor.

These various approaches make it possible in particular to establish in a secure manner the link between the patient and the doctor, to check that the person who uses the medical software device is indeed the patient who consulted the doctor, to remotely configure if necessary the software application prescribed according to the pathology to be treated, and to check if the latter is compliant with the computerised medical prescription.

As such, this invention through its innovative approach responds to the various safety and health issues raised today with the emergence of medical software devices.

It should be observed that this detailed description covers a particular embodiment of this invention, but that in no case does this description have a nature as to limit the object of the invention; on the contrary, it has for object to remove any possible inaccuracy or any incorrect interpretation of the following claims.

1-16. (canceled)

17. Method for activating a software application capable of executing software functions on a communication terminal in order to assist a patient in a therapeutic treatment determined according to a computerised medical prescription, said prescription, stored in a database connected to a remote central server, comprising personal prescription data containing information associated with the treatment prescribed to the patient,
with said method implemented by computer means comprising:
following an installation of said application on said communication terminal, a step of authentication with said central server of the patient via said communication terminal;
when said patient has authenticated himself with said central server, a step of remotely activating said application and said prescription data on the communication terminal in order to authorise the execution of at least one of said software functions on said communication terminal.

18. Method according to claim 17, wherein the step of activating comprises a transmission intended for the communication terminal of an activation message that comprises the prescription data and an activation order.

19. Method according to claim 17, wherein the step of authenticating comprises a comparison by the central server of a code received coming from the communication terminal with a unique prescription code recorded in said database.

20. Method according to claim 19, comprising a step of generating the unique prescription code according to said prescription data and a unique identification number associated with the patient.

21. Method according to claim 19, wherein the unique prescription code has the form of a two-dimensional matrix code.

22. Method according to claim 21, wherein the unique prescription code contains information concerning the configuration settings of the software functions.

23. Method according to claim 21, comprising a step of optical reading of the unique prescription code by the communication terminal.

24. Method according to claim 17, wherein the prescription data comprise information concerning:
the patient,
the practitioner,
the technical characteristics of the communication terminal used as a medical software device,
the configuration settings of the software functions, and/or
medication prescribed by the practitioner for the treatment of the patient such as for example the medication as such, the self-dosage rules for said medication by the patient himself, the dosage of said medication, the normal measurement values by the associated medical device, and/or the posology associated with said medication.

25. Method according to claim 17, comprising, following the step of authentication, a step of emitting during which the central server emits an access code with a limited duration to said communication terminal in order to authorise the activation of said application and of said prescription data.

26. Recording support that can be read by a computer whereon a computer program is recorded comprising instructions for the execution of the steps of the method for activating according to claim 17.

27. Computer system for activating a software application capable of executing software functions on a communication terminal in order to assist a patient in a therapeutic treatment determined according to a computerised medical prescription,
said prescription comprising personal prescription data containing information associated with the treatment prescribed to the patient,
said system comprising:
a database that stores said computerised medical prescription;
means for authentication able to cooperate with first means of communication for an authentication of the patient via the communication terminal whereon said application is installed;
activation means able to cooperate with said first means of communication in order to remotely activate said application and said prescription data on the communication terminal in order to authorise the execution of said functions on said communication terminal.

28. System according to claim 27, comprising computer means configured for the implementation of the steps of a method for activating a software application capable of executing software functions on a communication terminal in order to assist a patient in a therapeutic treatment determined according to a computerised medical prescription,
said prescription, stored in a database connected to a remote central server, comprising personal prescription data containing information associated with the treatment prescribed to the patient,
with said method implemented by computer means comprising:
following an installation of said application on said communication terminal, a step of authentication with said central server of the patient via said communication terminal;
when said patient has authenticated himself with said central server, a step of remotely activating said application and said prescription data on the communication terminal in order to authorise the execution of at least one of said software functions on said communication terminal, wherein the step of activating comprises a transmission intended for the communication terminal of an activation message that comprises the prescription data and an activation order.

29. Computer server comprising a computer system for activating according to claim 28.

30. Medical device comprising a communication terminal whereon a software application is installed, said software application being capable of executing software functions in order to assist a patient in a therapeutic treatment determined according to a computerised medical prescription,
said prescription, stored in a database connected to a remote central server, comprising personal prescription data containing information associated with the treatment prescribed to the patient,
said medical device comprising:
an electronic authentication circuit configured to authorise an authentication with said central server of the patient via said communication terminal; and
an electronic activation circuit configured to activate said application and said prescription data on the communication terminal in order to authorise the execution of at least one of said software functions on said communication terminal.

31. Device according to claim 30, wherein the electronic authentication circuit is able to cooperate with second means of communication in order to emit to said central server a request comprising a code to be compared with a unique prescription code recorded in said database, and wherein the electronic activation circuit is able to cooperate with second means of communication in order to receive from said server an activation message that comprises prescription data and an activation order.
